(19) United States
(12) Patent Application Publication
(10) Pub. No.: US 2013/0076987 A1
(43) Pub. Date: Mar. 28, 2013

(54) METHOD, AUDIO/VIDEO APPARATUS AND COMMUNICATION DEVICE

(71) Applicants: John Nicholas Wilson, Hook Hampshire (GB); John Christopher Clifton, Hook Hampshire (GB)

(72) Inventors: John Nicholas Wilson, Hook Hampshire (GB); John Christopher Clifton, Hook Hampshire (GB)

(73) Assignees: Sony Europe Limited, Weybridge Surrey (GB); Sony Corporation, Minato-ku, Tokyo (JP)

(21) Appl. No.: 13/636,538

(22) PCT Filed: Mar. 29, 2011
(86) PCT No.: PCT/GB2011/050639

§ 371 Date: Nov. 27, 2012

(30) Foreign Application Priority Data
Mar. 31, 2010 (GB) 1005438.5

(51) Int. Cl. H04N 5/50

(52) U.S. Cl. CPC H04N 5/50
USPC 348/731

(57) ABSTRACT

A method and apparatus reducing interference to reception of television signals received by a television receiver. The television receiver includes an antenna receiving television signals and a tuner selecting the television signals transmitted on a carrier signal. The interference is produced by a communication device transmitting radio communication signals that can be received by the television receiver when the tuner is tuned to the television signals. The method transmits a radio beacon signal from a location substantially same as a location of the television receiver, and if the radio beacon signal is detected at the communication device, adapts transmission of the radio communication signals from the communication device to reduce interference at the television receiver. As examples, the communications device is a mobile communications device, mobile telephone, personal computer, or a base station, for example disposed within a house for forming a femto cell.

### TECHNICAL FIELD

The present invention relates to methods of reducing interference at a television receiver produced by a communication device transmitting radio communication signals and communication devices and audio/video apparatus including television receivers.

### BACKGROUND OF THE INVENTION

The UHF (Ultra High Frequency) radio band covers a range of frequencies between 300 MHz to 3 GHz. Radio frequencies within the UHF band have particularly useful propagation and information bearing properties therefore many systems which rely on the communication of information using radio waves are designed to transmit and receive information on radio signals using the UHF radio band.

To ensure a fair and organised allocation of the UHF spectrum for different uses, regulatory bodies, such as the Office of Communications (OFCOM) in the UK and the Federal Communications Commission (FCC) in the United States, divide the UHF spectrum into different frequency bands and allocate each band to a certain group of users and uses.

As time progresses, it becomes necessary for the regulatory bodies to re-organise the allocation of the UHF spectrum to accommodate new technologies which communicate using the UHF spectrum and to account for the demise of older technologies which no longer justify a reserved section of the spectrum. The task of reallocating bands of the UHF spectrum is not always made purely with technical considerations in mind.

For example, in the UK after 2012, radio transmitters broadcasting television signals using the PAL (phase alternating line) analogue transmission mode on the so-called “800 MHz band” will cease transmitting. The “800 MHz band” refers to a range of frequencies between 790 MHz and 862 MHz. These frequencies will be re-allocated by OFCOM for other uses. It is possible that some of the frequencies within the 800 MHz band will be retained for the transmission of digital television signals. However, other frequencies may be allocated to so-called “fourth generation” mobile communications services. As a result mobile communication devices (such as mobile telephones and other portable devices such as laptops, notebooks, camcorders, camera with built in wireless communications functionality) can be expected to be deployed which transmit and receive radio signals on frequencies within the 800 MHz band. As fourth generation communication devices become more widespread, this may cause interference problems with devices for receiving television signals such as televisions, personal video recorders (PVRs), set-top boxes and so on.

### SUMMARY OF THE INVENTION

This invention claims priority from UK patent application 1005438.5 the entire content of which is incorporated by reference.

According to a first aspect of the present invention there is provided a method of reducing interference to the reception of television signals received by a television receiver. The television receiver comprises an antenna for receiving the television signals and a tuner for selecting the television signals transmitted on a carrier frequency band. The interference is produced by a communication device transmitting radio communication signals on a frequency band that can be received by the television receiver when the tuner is tuned to the television signals. In one example the communications device is a mobile communications device, such as a mobile telephone or personal computer. In another example the communications device maybe a base station, such as for example a base station, which is disposed within a house for forming a femto cell. The method comprises transmitting a radio beacon signal from a location that is substantially the same as a location of the television receiver, and if the radio beacon signal is detected at the communication device, adapting the transmission of the radio communication signals from the communication device to reduce interference at the television receiver.

Conventionally, devices for receiving television signals such as televisions, personal video recorders (PVRs), set-top boxes and so on, include a television receiver that is arranged to receive broadcast television signals. However, the present invention recognises that by adapting this conventional arrangement such that a radio beacon signal is transmitted from the location of the television receiver, a communication device, such as a mobile communication device or base station can be alerted to the presence of a device including a television receiver that might be susceptible to interference, and take action accordingly to reduce the likelihood of interference caused by radio communication signals transmitted from the communication device. The provision of a radio beacon signal transmitter at a television receiver is an inexpensive and convenient adaptation that is unlikely to affect the complexity, cost or power consumption of an apparatus, such as a television, to which the adaptation has been made. Moreover, there is no need for any manual intervention by either a user of the television receiver or a user of the communication device to ensure that the transmission of the radio communication signals from the communication device is adapted to reduce interference at the television receiver.

Furthermore, modern communication devices such as mobile communication devices and base stations (including user installed short-range base station sometimes referred to as “femtocell” base stations) include transceivers capable of receiving most radio signals. Therefore enabling a communication device to adapt the transmission of the radio communication signals from communication device to reduce interference at the television receiver is likely to require no more than a software/firmware upgrade. Therefore, in accordance with the present invention, communication devices can be modified to reduce interference caused at television receivers without the need for any additional hardware.

In accordance with one embodiment of the present invention, the method includes determining at the communication device a received power of the detected radio beacon signal, and adapting the transmission of the radio communication signals from communication device to reduce interference at the television receiver in accordance with the received power of the detected radio beacon signal.

The power of the radio communication signals when they are received at the television receiver will determine the amount of interference that may occur at the television receiver. If the power of the radio communication signals is very high, a great deal of interference may occur. If it is very low, a negligible amount of interference may occur. The power of the radio communication signals when they are received at the television receiver is a function of the power at which the radio communication signals are transmitted from the communication device and the path loss between the communication device and the television receiver. The path loss is dependent on factors including the nature of the physical space between the communication device and the television receiver, and the distance between the communication device and the television receiver. For example, the path loss will be greater if a physical object such as a wall is situated between the communication device and the television receiver and will also be greater the larger the distance separating the communication device and the television receiver. Between the communication device and the television receiver, the radio beacon signal and the radio communication signals will be travelling in opposite directions. However, they will be travelling across the same space and will therefore experience a similar path loss. Accordingly, the power of the received radio beacon is indicative of the path loss experienced by the radio communication signals as they travel to the television receiver and thus also indicative of the power of the radio communication signals at the television receiver which, as explained above, is itself indicative of the amount of interference that might occur at the television receiver. In accordance with this embodiment, the fact that the path loss is similar for both the radio beacon and the radio communication signals can be exploited to control how and at what point the transmission of the radio communication signals is adapted.

In accordance with another embodiment, an interference power of the communication radio signals at the television receiver is calculated based on the received power of the radio beacon signal. If the calculated interference power is above a threshold level, the transmission of the radio communication signals from communication device is adapted to reduce interference at the television receiver.

This embodiment provides an advantage in that rather then simply determining if the received radio beacon signal is above a threshold power, an estimation is made of the actual power of the interfering signals at the television receiver. This allows a more accurate prediction of whether or not the television receiver is likely to experience interference from the radio communication signals transmitted from the communication device.

In accordance with another embodiment, the received power of the radio beacon signal and a value corresponding to a predetermined power at which the transmitter transmits the radio beacon signal is known at the communication device and is used to determine an attenuation value of the power of the radio beacon signal between the transmitter and the communication device. The interference power of the radio communication signals at the television receiver is then determined by applying the attenuation value to a power at which the radio communication signals are transmitted from the communication device.

In accordance with this embodiment, the interference power of the radio communication signals at the television receiver is determined based on values that are known at the communication device, i.e. the power of the radio beacon signal received at the communication device and the transmit power of the radio communication signals from the communication device; and values that can be stored at the communication device, i.e. a predetermined power at which the radio beacon signal is transmitted. A convenient method is therefore provided for estimating the interference power of the radio communication signals transmitted from the communication device as those signals are received at the television receiver. As a result, the interference power can be calculated at the communication device without the need for any other information exchange between the television receiver and the communication device.

In accordance with one embodiment, the adapting of the transmission of the radio communication signals from the communication device to reduce interference at the television receiver comprises changing a frequency band on which the radio communication signals are transmitted from the communication device from a first frequency band to a second frequency band.

The interference caused by the communication device will be due in part to the frequency on which the radio communication signals are being transmitted. Accordingly, in order to reduce the interference experienced at the television receiver, in this embodiment the frequency band on which the communication device is transmitting the radio communication signals is switched from a first band (which causes interference) to a second band (which causes reduced interference).

In accordance with a second aspect of the invention there is provided an audio/video apparatus including a television receiver for receiving broadcast television signals. The audio/video apparatus includes a radio beacon transmitter for transmitting a radio beacon signal in accordance with the method described above.

In accordance with a third aspect of the invention there is provided a communication device comprising a transmitter for transmitting radio communication signals, a receiver arranged to receive a beacon signal transmitted from an audio/video apparatus and a processor arranged on reception of the radio beacon signal to adapt the transmission of the radio communication signals to reduce interference at the audio/video apparatus. In one example the communication device is a mobile communication device. In another example the communication device is a base station for transmitting radio communication signals to and receiving radio communication signals from at least one mobile communication device.

Various further aspects and features of the invention are defined in the appended claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 shows a schematic diagram illustrating an example allocation of frequency bands within a portion of the 800 Mhz band;

FIG. 2 shows a schematic diagram providing a representation of a conventional television situated near a mobile communication device;

FIG. 3 shows a schematic diagram providing a representation of a television arranged in accordance with an embodiment of the invention situated near a communication device such as a mobile communication device or a base station;

FIG. 4 shows a schematic diagram providing a representation of a number of televisions arranged in accordance with the present invention near a communication device such as a mobile communication device or a base station;

FIG. 5 shows a schematic diagram providing a representation of a television and a mobile communication device arranged in accordance with an embodiment of the present invention;

FIG. 6 shows a schematic diagram providing a representation of a user using a mobile communication device near a television arranged in accordance with an embodiment of the present invention;

FIG. 7 shows a schematic diagram providing representation of a television arranged in accordance with an embodiment of the invention, and

FIG. 8 shows steps of a method according to an embodiment of the present invention.

### DETAILED DESCRIPTION

The following description of the present invention is provided mainly in terms of televisions, i.e. stand alone television sets. However, it will be appreciated that the present invention may be implemented in respect of any suitable apparatus which includes a receiver for receiving television signals such as personal video recorders (PVRs), set-top boxes, personal computer (PC) expansion cards for allowing a user to watch television on a PC, computer games consoles such as a Sony PlayStation including a television receiver peripheral such as the Sony PlayTV device, and so on. Furthermore, the following description is provided mainly in terms of the communication device being a mobile communication devices (such as a mobile telephone) operating in the vicinity of a television receiver. This is because the nature of mobile communications is more likely to produce a scenario in which a mobile user moves to a position in which radio signals transmitted by the mobile communications device or to be received by the device interfere with a television receiver, because of the location of the mobile device. However, as will become apparent, the principles of the present invention find equal application when the communication device is a base station operating in the vicinity of a television receiver. The base station is typically a substantially static communication device for transmitting radio communication signals to and receiving radio communication signals from mobile communication devices. In one example the base station may be disposed in a house to form a femto cell.

In regions such as Europe, a radio signal transmitted in the 800 MHz band by a mobile communication device in the vicinity of a television is likely to be received by the television receiver of the television. A television typically comprises a television signal receiver for receiving a television signal, a demodulator for demodulating the received television signals and a screen and speakers for reproducing audio and video information extracted from the demodulated television signal.

The television receiver typically includes an antenna for receiving television signals and a tuner for filtering out all but the desired section of the television signal.

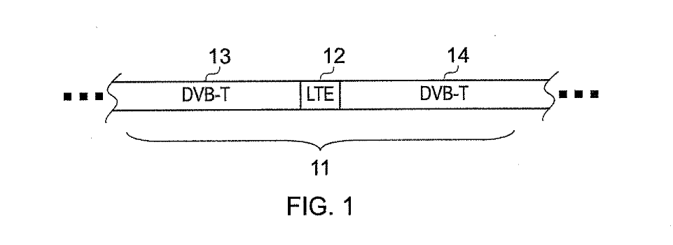

Due to the allocation of the frequencies within the UHF band, it is unlikely that a television receiver will be tuned to receive television signals on the same frequency band that a mobile communication device is transmitting on. However, if the television receiver is tuned to receive television signals on a frequency that is also within the 800 MHz band, the proximity of the frequency band on which the mobile communication device is transmitting may be close enough to interfere with the television signal received by the television. This concept is illustrated in FIG. 1.

FIG. 1 provides a schematic diagram illustrating an example allocation of frequency bands within a portion of the 800 Mhz band 11. As can be seen, a narrow section 12 of the frequency band has been allocated to “LTE” mobile communication services either side of which are two sections of the frequency band 13, 14 which have been allocated for the transmission of digital television signals. If a television receiver is tuned to receive television signals broadcast on the first band 13 or the second band 14, mobile radio communication signals transmitted on frequencies within the LTE band 12 are likely to interfere with the signal received by the television receiver.

A conventional way to address this problem would be to fix a filter to the television antenna of the television receiver. The filter would be designed to exclude all radio signals broadcast on the frequencies within the 800 MHz band allocated for use by mobile communication devices. In other words all the frequencies within the LTE band 12 shown in FIG. 1. However, this solution is unlikely to mitigate interference in all cases. Television receivers are typically very sensitive so as to be able to receive signals broadcast from transmitters that are up to several tens of kilometres away. Therefore, radio signals transmitted from a mobile communication device in the immediate vicinity of the television may penetrate the television itself, thus “bypassing” the antenna filter, and are likely to be detected by the television receiver and cause interference.

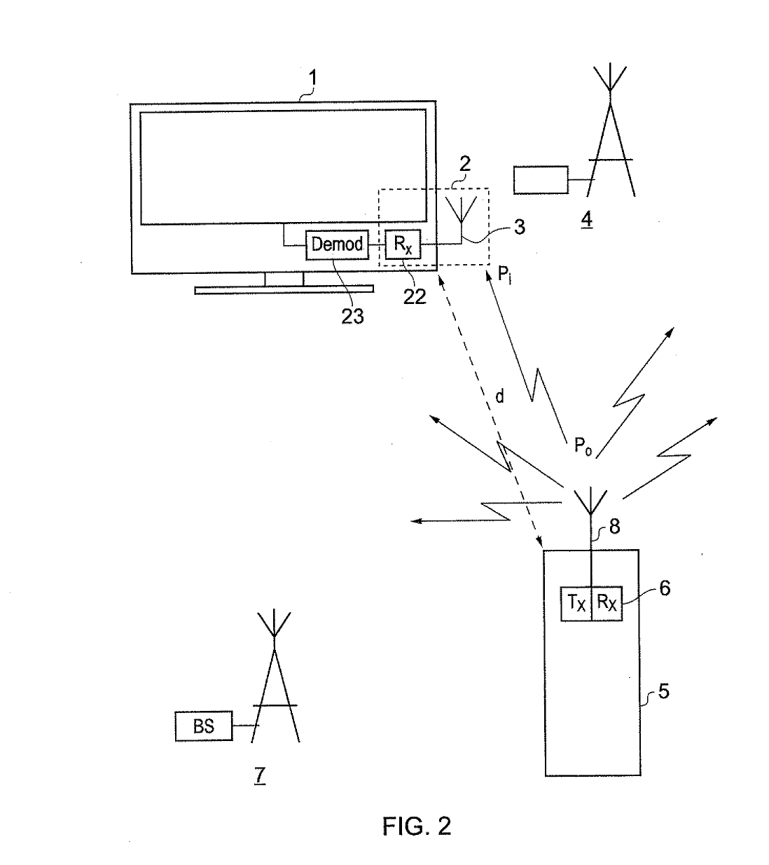

Interference at a television receiver is explained further with reference to FIG. 2.

FIG. 2 shows a schematic diagram illustrating various parts of a conventional television 1, which includes a receiver 2. For clarity, various parts of the television have been omitted such as amplifier stages and so on but these parts are known in the art.

The receiver 2 includes an antenna 3 that intercepts radio signals broadcast from a television transmitter station 4 and a tuner 22 which is arranged to filter out all signals apart from those associated with a television channel to be received by the television 1. After the television signal has been filtered by the tuner 22, a demodulator 23 demodulates the selected signal and converts it into audio/video information that can be reproduced by the television 1 as sound and pictures.

FIG. 2 also shows a mobile communication device 5 situated near the television 1. The mobile communication device 5 includes a transmitter/receiver unit 6 which receives and transmits radio communication signals to and from a base station 7 via an antenna 8.

If the frequency band on which the mobile communication device 5 is transmitting radio signals is sufficiently close to the frequency band that the tuner 22 in the receiver 2 is tuned to receive, the radio signals from the mobile communication device 5 will not be filtered out by the tuner 22 and may interfere with the signals to be demodulated by the demodulator 23.

Interference with the signals to be demodulated by the demodulator 23 will result in a reduction in the quality of the sound and picture reproduced by the television 1.

The interference experienced by the television will be dependent on the power, Pᵢ, of the signal from the mobile communication device at the location of the television 1. In other words Pᵢ is the power of the signal after it has travelled from the mobile communication device 5 to the television 1.

If Pᵢ is very low, the interference will not be very significant and may not result in a noticeable reduction of the quality of the sound and picture produced by the television 1. If Pᵢ is high, the interference will be significant and if high enough could significantly distort the sound and picture produced by the television 1.

In order to avoid interference from the mobile communication device 5, a threshold value for Pᵢ can be defined, P_{i-threshold}.

P_{i-threshold} can be defined by identifying a maximum power of the interfering radio signal (i.e. a radio signal transmitted on a frequency that interferes with the signal received by the television 1) which the receiver 2 of the television 1 can tolerate before the quality of the sound and picture reproduced by the television 1 begins to noticeably deteriorate. P_{i-threshold} would typically be set at some value below this maximum signal power.

Pᵢ will be a function of the following variables:
Pₒ, the power with which the mobile communication device 1 is transmitting the radio communication signals;
h, the channel via which the signal from the mobile communication device travels before reaching the television 1.
d, the distance between the mobile communication device 5 and the television 1;

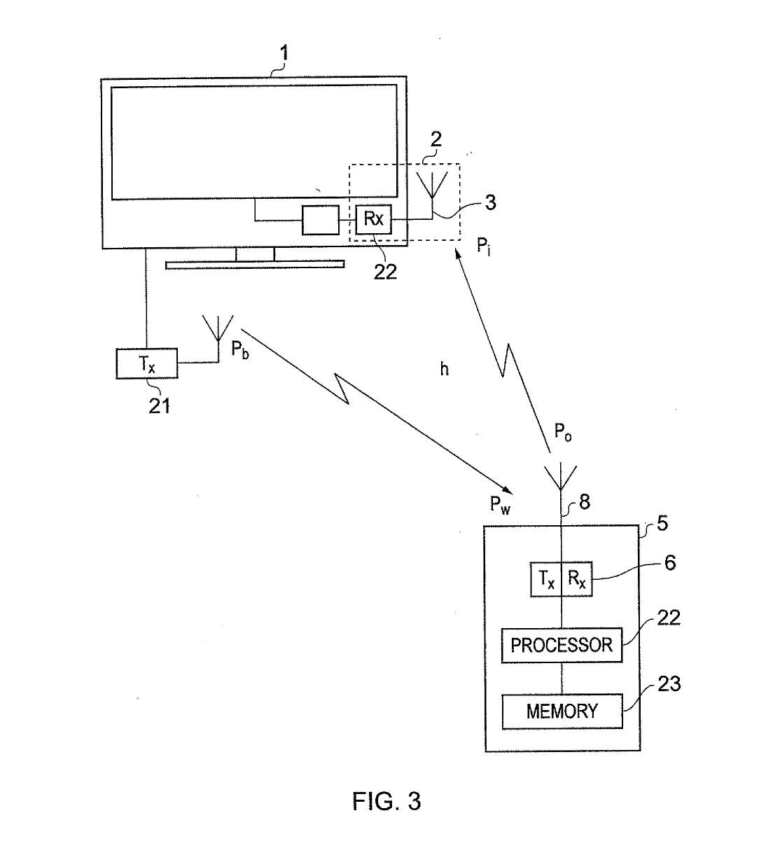

FIG. 3 shows a schematic diagram of a system arranged in accordance with the present invention.

In FIG. 3 the television 1 is provided with a radio beacon transmitter 21. The radio beacon transmitter 21 may be any suitable transmitter for transmitting short-range radio signals. In some embodiments the radio beacon transmitter 21 may transmit radio signals in accordance with common short-range radio protocol such as Bluetooth or WiFi. These short range radio protocols typically transmit radio signals within a range of a few tens of metres. The radio beacon transmitter 21 is arranged to transmit a radio beacon signal at a fixed pre-determined power P_{b}.

The transmitter/receiver unit 6 of the mobile communication device 5 is arranged to detect the radio beacon signal transmitted from the radio beacon transmitter 21. Typically, the radio beacon will be transmitted in such a way that the mobile communication device 5 is able to distinguish it from other received signals and thereby determine that it is a radio beacon transmitted from a television. This may be achieved in a number of ways for example applying a particular phase or frequency modulation to the beacon, or transmitting it on a particular sub-channel if the radio beacon is transmitted using a spread spectrum scheme. In some examples the radio beacon may include an identifier for identifying the television. The transmitter/receiver unit 6 is connected to a processor 22. The processor 22 is arranged to determine the power of the radio beacon signal.

The power P_{w} of the radio beacon signal received by the mobile communication device 5 will be a function of the power P_{b} of the radio signal beacon broadcast by the radio beacon transmitter 21 and the path loss between the mobile communication device and the television 1. The path loss will be a function of the distance d between the mobile communication device and the television 1, and the channel h.

The mobile communication device 5 includes a memory 23 in which is stored a value corresponding to P_{i-threshold} and a value corresponding to the fixed power level P_{b}.

Assuming that the radio beacon signal transmitted by the radio beacon transmitter 21 is transmitted on a frequency band that is similar to the frequency band on which the radio signal from the mobile communication device 5 is transmitted, the path loss experienced by the radio signal transmitted from the mobile communication device 5 across the channel h, will be approximately the same as the attenuation experienced by the radio beacon signal transmitted by the transmitter 21 across channel h. In other words:

P_{b}−P_{w}≈Pₒ−Pᵢ equation (1)

Rearranging equation (1) gives:

Pᵢ=Pₒ+P_{w}−P_{b} equation (2)

The approximation of equation 1 is based on the assumption that the frequency bands are similar (for example within 20% of each other). However, even if the frequencies are further apart then this, a path loss frequency correction factor can be used. The free space loss of the signals travelling between the radio beacon transmitter 21 and the mobile communication device 5 is a known function of distance and frequency. Specifically it is governed by the following equation:

$$Free space loss = {( \frac{4 π df}{c} )}^{2} \qquad equation ( 3 )$$

Accordingly if the frequency separation between the frequency bands is known, then received powers P_{w} and Pᵢ can be corrected accordingly.

As mentioned above, the processor 22 can determine the power P_{w} of the signal received from the radio beacon transmitter 21. Also, the transmitter/receiver unit 6 controls the power Pₒ with which radio signals are transmitted from the mobile communication device 1 and therefore Pₒ is known at the mobile communication device 5.

Accordingly, as the memory 23 includes a value representing P_{b}, the processor 22 can be arranged to estimate the power Pᵢ of the radio signal transmitted from the mobile communication device 5 at the television using equation (2).

As the mobile communication device also has stored in the memory 23 a value corresponding to P_{i-threshold}, the mobile communication device 5 can determine if the power of the radio signal it is transmitting is being received at the television 1 at a level that is above the acceptable power level defined by P_{i-threshold}, i.e.:

P_{i-threshold}≦Pₒ+P_{w}−P_{b} equation (4)

Once the mobile communication device 1 determines that Pᵢ≧P_{i-threshold}, it can be assumed that the power Pₒ at which the transmitter/receiver unit 6 is transmitting will cause interference at the television receiver.

Once the mobile communication device detects that Pᵢ≧P_{i-threshold}, the processor 22 is arranged to control the transmitter/receiver unit 6 to perform an interference power reduction operation which will cause the interference power Pᵢ to drop below P_{i-threshold}.

In some embodiments the interference reduction operation includes switching the frequency of radio signals transmitted from transmitter/receiver unit 6 to a different frequency band which will not interfere with the television signal received by the television.

In other embodiments the interference reduction operation may include reducing the power of the transmitted signal Pₒ so that Pᵢ<P_{i-threshold}. Alternatively, the mobile communication device 5 may simply cease transmitting radio signals all together or on a particular channel.

In some embodiments, the mobile communication device 5 may be arranged to produce a notification to a user such as an audible sound or visual indication indicating that the mobile communication device 5 is transmitting at a power level likely to cause interference at the television 1. The user can then choose to take corresponding action, for example moving the mobile communication device 5 further from the television 1 thus increasing the distance d and therefore increasing the path loss.

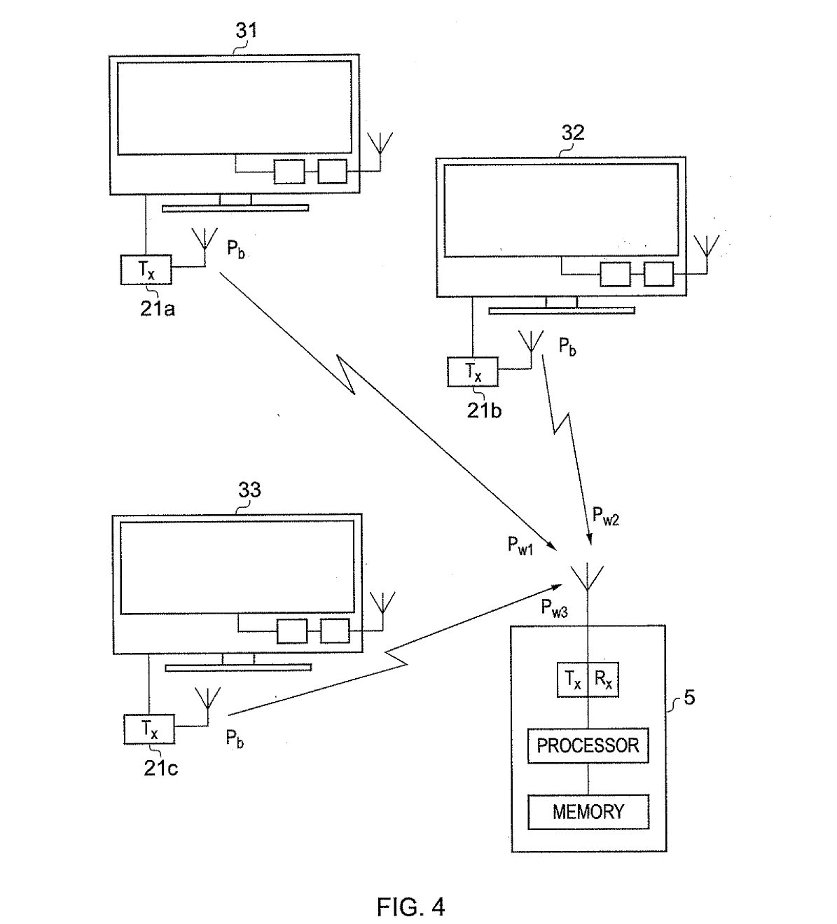

The mobile communication device 5 can be adapted to perform the interference reduction operation in the presence of several televisions as shown in FIG. 4.

FIG. 4 shows a first television 31, a second television 32 and a third television 33 arranged at different positions. Accordingly, the power of the interfering signal Pᵢ at each television will be different. A situation may arise therefore whereby the power of the interfering signal Pᵢ at one or more televisions is below P_{i-threshold} whilst the power of the interference signal at one or more other televisions is at, or above, P_{i-threshold}.

As the televisions are arranged at different positions, each television is at a different distance from the mobile communication device 5 and transmitting its radio beacon signal via a different channel h. Accordingly, the mobile communication device 5 will receive radio beacon signals from each television at different powers P_{w1}, P₂ and P_{w3}. Although there is no need for the mobile communication device to be able to specifically identify the source of each radio beacon signal, the radio beacon signals will be such that it can be determined by the mobile communication device 5 that each radio beacon signal originates from a different transmitter 21a, 21b, 21c. This may be achieved in a number of ways for example applying a different phase or frequency modulation to each beacon, or transmitting each radio beacon on a different sub-channel if the radio beacons are transmitted using a spread spectrum scheme.

In order to ensure that the power of the interference signal Pᵢ is below P_{i-threshold} at all the televisions, the processor 22 of the mobile communication device is arranged to determine which of the received radio beacon signals has the greatest power (i.e. which of P_{w1}, P_{w2} and P_{w3} has the highest value) and using this value determine the power of the interfering signal at the television where the power of the interfering signal is highest. If this value is greater than P_{i -threshold}, then the processor 22 is operable to perform the interference power reduction operation as described above.

In some embodiments, rather than calculate the interference power Pᵢ of the radio communication signals at the television 1, the mobile device may be arranged simply to perform the interference power reduction operation when either a radio beacon signal is detected or when the radio beacon signal reaches an arbitrary threshold power level, P_{w-threshold}, at the mobile communication device 5.

In some embodiments, the television 1 may be arranged to activate the transmitter 21 only when that television is reproducing sound and pictures from a broadcast television signal. When the television 1 is being used for other functions such as reproducing sound and pictures from storage media such as a hard drive or a DVD, the transmitter 21 will be switched off. The transmitter may also be switched off if the television is being used for functions such as displaying the output of a games console such as a Sony PlayStation or any other device.

### Example Implementation

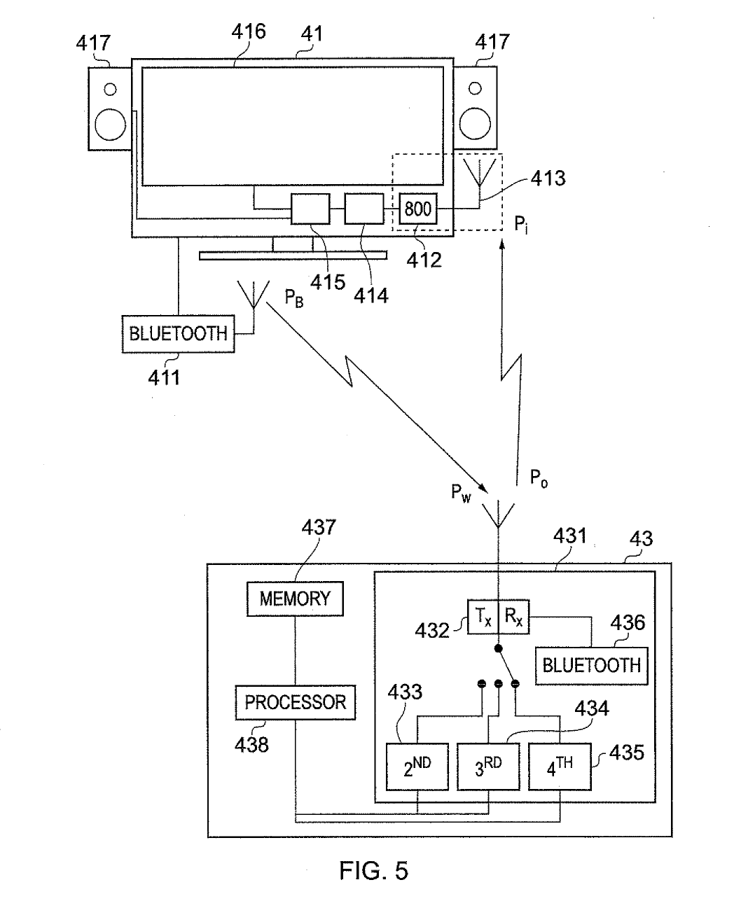

FIG. 5 provides a schematic diagram illustrating an example implementation of the present invention in which the mobile communication device is a multi-band mobile telephone 43 and the radio beacon transmitter is a Bluetooth transceiver 411 incorporated with a television 41.

The television 41 includes a tuner 412 connected to an antenna unit 413 for receiving and amplifying television broadcast signals. The tuner unit 412 and the antenna unit 410 together comprise the television receiver of the television 410. The tuner 412 is tuned to select signals broadcast within the 800 MHz frequency band. The tuner 412 is connected to a demodulator 414 which demodulates the tuned signal provided by the tuner 412. An audio/video reproduction unit 415 receives demodulated signals from the receiver unit 412 and converts them into an audio/video signals which can be output on a screen 416 and on speakers 417.

If the tuner 412 is tuned to receive television broadcast signals broadcast on a frequency within the 800 Mhz band, then radio signals transmitted near the television on a frequency of around 800 Mhz, if powerful enough, may interfere with the quality of the sound and picture produced by audio/video reproduction unit 414.

The multi-band mobile telephone 43 shown in FIG. 5 includes a multi-band transceiver unit 431 capable of transmitting and receiving information to and from a base station in accordance with a number of different wireless communication modes. These communication modes include a “second generation” communication mode (e.g. GSM/GPRS), a “third generation” communication mode (e.g. UMTS) and a “fourth generation” communication mode (e.g. LTE).

The communication modes typically support differing levels of service. For example, second generation communication modes may support circuit switched voice calls and data rates of a few kilobits/s, whereas fourth generation communication modes may support video calls and data rates of several tens of megabits/s.

Each communication mode uses a particular section of the frequency spectrum. In other words, when communicating in accordance with a given communication mode, the mobile telephone 43 and the base station communicate on a frequency band/bands allocated to that communication mode. The following table provides example frequency band allocation:

TABLE 1

| Communication Mode | Frequency Band/Bands |
|---|---|
| Second generation | 900 MHz and 1800 MHz |
| Third generation | 1900 MHz |
| Fourth generation | 820 MHz |

The transceiver unit 431 within the mobile communication device also includes a receiver/transmitter unit 432 and three sub-transceiver units 433, 434, 435. The receiver/transmitter unit 432 transmits and receives radio signals in accordance with one of three communication modes. The first sub-transceiver unit 433 provides communication functionality in accordance with a second generation communication mode; the second sub-transceiver unit 434 provides communication functionality in accordance with a third generation communication mode, and the third sub-transceiver unit 435 provides communication functionality in accordance with a third generation communication mode.

The transceiver unit 431 is arranged to switch between the three communication modes. For example, the mobile telephone may switch from communicating using the third generation communication mode to communicating using the second-generation mode if the quality of the signal in the 1900 MHz band deteriorates but the quality of the radio signal in the 900 MHz band is acceptable.

The transceiver unit 431 in the mobile telephone 43 also includes a Bluetooth unit 436 enabling it to communicate with nearby devices using the Bluetooth protocol. Although not shown in FIG. 5, the Bluetooth unit may include its own separate antenna. Similarly, the three sub-transceiver units 433, 434, 435 may include their own individual transceiver units and antennae.

The mobile telephone 43 is arranged to be able to switch between the three communication modes. For example, the mobile telephone 43 may switch from communicating using the third generation communication mode to communicating using the second-generation mode if the quality of the signal in the 1900 MHz band deteriorates but the quality of the radio signal in the 900 MHz band is acceptable. However, the transceiver 431 is arranged, where possible, to always communicate in accordance with the fourth generation protocol as this typically provides a user with the best data rates and most advanced services.

When the television 41 is on, the Bluetooth transceiver 411 is switched to the Bluetooth “discover mode”. The discover mode enables Bluetooth devices to “discover” other Bluetooth devices that are within range and that are in the Bluetooth “discoverable” mode. This is achieved by the Bluetooth transceiver periodically transmitting a paging message. The Bluetooth transceiver 411 is adapted to ensure that it transmits the paging message to the mobile telephone 43 at a fixed predetermined power, P_{b}, for example 100 mW.

The mobile telephone 43 includes a memory 437 in which is stored a value corresponding to P_{b} and a value corresponding to P_{i-threshold}.

When the television 41 is switched on, the Bluetooth transceiver 411 begins transmitting the paging message at the fixed predetermined power, P_{b}.

Assuming that the Bluetooth unit 436 in the mobile telephone 43 is in the discoverable mode, when in range of the Bluetooth transceiver 411 of the television 41, the mobile telephone 43 will detect the paging message transmitted from the Bluetooth transceiver 411. The paging message includes an identifier which enables the Bluetooth unit 436 of the mobile telephone 43 to determine that it is a beacon transmitted from a television. This can be achieved by providing the Bluetooth transceiver 411 with a Bluetooth identity such as “Television 1”. When the Bluetooth unit 436 receives the paging message, it identifies the paging message as a beacon associated with the television 41, measures the strength of the signal P_{w} and sends this to the processor 438.

The power Pₒ with which the mobile telephone 43 transmits the radio communication signals is controlled by the processor 438 and is therefore known at the mobile telephone 43. The strength of the received paging signal P_{w} is measured and sent to the processor 438 as described above. Accordingly, all the parameters required to estimate the interference power Pᵢ using equation (2) are known and the processor 438 can calculate the interference power, Pᵢ, of the signal transmitted from the mobile telephone 43.

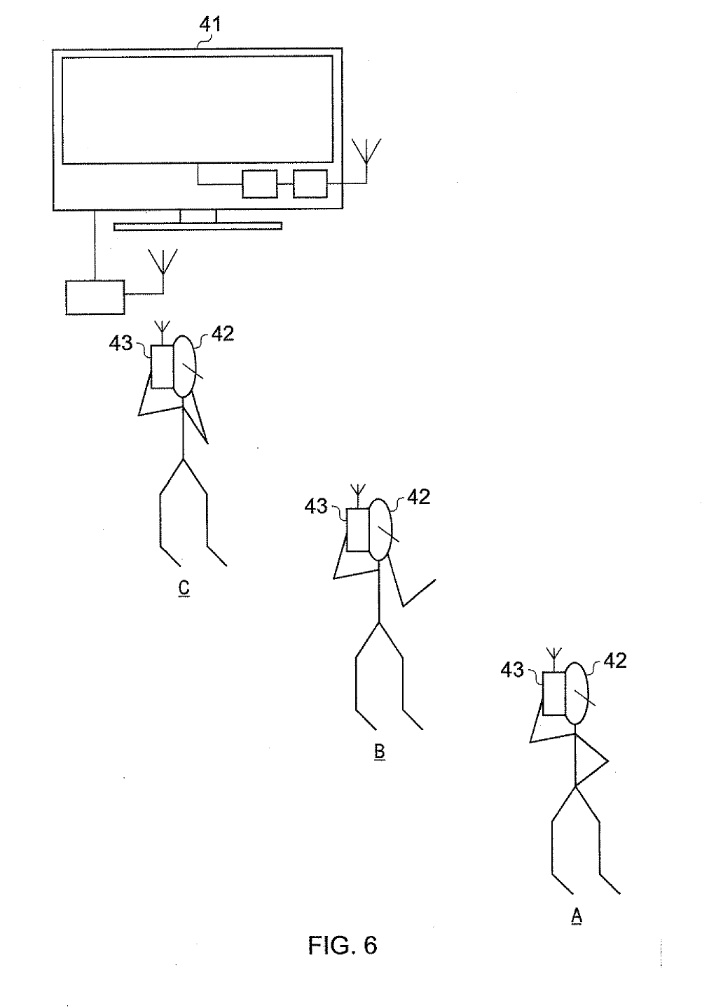

FIG. 6 illustrates the use of the system shown in FIG. 5. A user 43 is shown using the mobile telephone 43 in the fourth generation communication mode. The user is shown at three positions A, B and C. Position A is the furthest from the television 41 and position C the closest.

As mentioned above, where possible mobile telephone 43 communicates using the fourth generation communication mode and therefore transmits radio signals within the 800 Mhz frequency band.

However, the television 41 is also tuned to receive television broadcast signals within the 800 MHz frequency band. Accordingly, if the mobile telephone 43 gets sufficiently close to the television 41 and Pᵢ becomes greater than P_{i-threshold}, then the picture and sound quality produced by the television 41 is likely to deteriorate.

When the user 42 is at the first position A, the mobile telephone 43 is out of range of the Bluetooth transceiver 411 and does not detect the paging message. No action is taken.

The user 42 then moves to the second position B. Position B is sufficiently close to the television 41 that the paging message transmitted from the Bluetooth transceiver 411 can be received at the mobile telephone 43. The power of the paging message P_{w} is measured and the strength of the paging message signal, Pᵢ, is calculated.

At position B, Pᵢ<P_{i-threshold} therefore no action is taken.

The user then moves to position A. At position A, Pᵢ>P_{i-threshold}.

The processor 438 detects that Pᵢ is now greater than the permitted threshold P_{i-threshold} and controls the transceiver unit 431 to switch to a different communication mode, for example the third communication mode provided by the third generation communication mode sub-transceiver 434.

As shown in Table 1, when using the third generation communication mode, the mobile telephone transmits signals on the 1900 MHz frequency band. This is sufficiently spaced from frequencies within the 800 MHz frequency band and therefore will not interfere with the television signal received by the television.

Although the example implementation described above uses the Bluetooth short range radio protocol, it will be appreciated that it would be equally appropriate to replace the Bluetooth transceiver 411 and the Bluetooth unit 436 with suitable equivalents, such as either WiFi based transceivers or ZigBee based transceivers. Both these radio protocols would permit a radio beacon to be transmitted from the television which could be identified by the mobile telephone as a beacon transmitted from the television. In some examples the mobile telephone and/or the transceiver unit in the television will include “in-built” WiFi functionality and the addition of a Bluetooth unit in the mobile telephone and Bluetooth capability in the transceiver of the television will be provided as an add on feature or component at a later time.

In FIGS. 2, 3, 4 and 5 the radio beacon transmitter has been illustrated as being external to the television. In some examples this will be the case, for example the radio beacon transmitter can be manufactured and sold separately to the television. A user might then separately purchase the radio beacon transmitter and attach it to a previously installed television. In other examples, the radio beacon transmitter might not be physically attached to the television at all and may instead simply be positioned near the television.

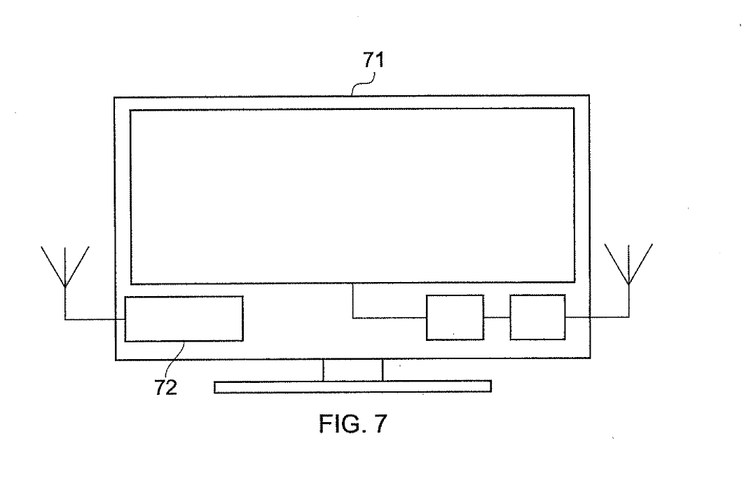

FIG. 7 provides a schematic diagram illustrating another example of the present invention in which a radio beacon 72 transmitter is located within a television 71.

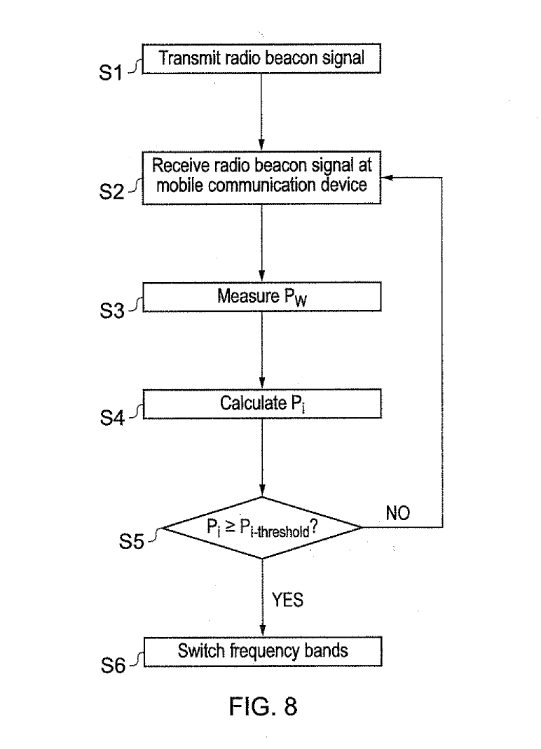

FIG. 8 shows a flow diagram illustrating a method according to an embodiment of the present invention.

At step S1 a radio beacon signal is transmitted from a location corresponding to a television receiver. At step S2 the radio beacon signal is received at the mobile communication device. At step S3 the mobile communication device measures P_{w}, the power of the received radio beacon signal. At step S4 the mobile communication device calculates Pᵢ, the interference power at the television receiver of the radio communication signals transmitted from the mobile communication device. At step S5, the mobile communication device determines if Pᵢ is greater that P_{i-threshold}. If Pᵢ is greater that P_{i-threshold} then at step S6 the mobile communication device switches from transmitting on a first frequency band to transmitting on a second frequency band. Various modifications can be made to the example embodiments described above without departing from the scope of the invention. For example, although the audio/video apparatus has been described above in terms of a television, it will be appreciated the present invention also applies to other audio/video apparatus that include television receivers such as personal video recorders for recording broadcast television, personal computers that include a television receiver expansion card, computer games consoles such as a Sony PlayStation including a television receiver peripheral such as the Sony PlayTV device, and so on. Furthermore, as set out above, the principles of the present invention find equal application when the communication device is a base station (i.e. a substantially static communication device for transmitting radio communication signals to and receiving radio communication signals from mobile communication devices). It will be appreciated that in these circumstances for example, the communication device 5 shown in FIGS. 3 and 4 is a base station for communicating with other mobile communication devices. Accordingly, the present invention may find particular application in a situation in which a user installs a base station (such as a fourth generation femtocell base station) in their home. In this situation the user may install the base station too close to a television receiver, and thus, as described above, the base station, upon detecting the radio beacon signal is arranged to adapt the transmission of radio communication signals from the base station.

1-28. (canceled)

29. A method of reducing interference to reception of television signals received by a television receiver, the television receiver comprising an antenna for receiving the television signals and a tuner for selecting the television signals, which are transmitted on a carrier signal within a frequency band, and the interference is produced by a mobile communication device transmitting radio communication signals on a frequency that can be received by the television receiver when the tuner is tuned to the television signals, the method comprising:
transmitting a radio beacon signal from a location that is substantially same as a location of the television receiver using a second antenna; and
if the radio beacon signal is detected at the mobile communication device, adapting the transmission of the radio communication signals from the communication device to reduce interference at the television receiver;
wherein the transmitting the radio beacon signal includes:
detecting when the television is reproducing sound and pictures from the television signals, and
transmitting the radio beacon signal only when the television is reproducing sound and pictures from the television signals.

30. A method as claimed in claim 29, wherein the detecting when the television is reproducing sound and pictures from the television signals includes detecting when the television is being used to reproduce sound and pictures from functions other than the television signals; and
the transmitting the radio beacon signal only when the television is reproducing sound and pictures from the television signals includes switching the radio beacon signal off when the television is reproducing sound and pictures from the other functions.

31. A method as claimed in claim 30, wherein the other functions include reproducing sound and pictures from one of a storage media or from a games console.

32. A method according to claim 29, wherein the frequency band within which the television signals are received is 800 MHz frequency band, and the frequency on which the radio communication signals transmitted by the mobile communication device are transmitted is within the 800 MHz frequency band.

33. A method according to claim 29, wherein the 800 MHz frequency band comprises frequencies between 790 and 862 MHz.

34. A method according to claim 29, further comprising correcting for a path loss difference between the radio beacon signal and the radio communication signals transmitted from the mobile communication device by applying a free space loss correcting factor to the radio beacon signal received at the mobile communication device.

35. A method according to claim 29, further comprising, if the radio beacon signal is detected at the mobile communication device:
determining at the mobile communication device a received power of the detected radio beacon signal; and
adapting the transmission of the radio communication signals from the mobile communication device to reduce interference at the television receiver in accordance with the received power of the detected radio beacon signal;
wherein the adapting of the transmission of the radio communication signals in accordance with the received power of the radio beacon signal comprises:
calculating an interference power of the radio communication signals at the television receiver based on the received power of the radio beacon signal, by using the received power of the radio beacon signal and a value corresponding to a predetermined power at which the transmitter transmits the radio beacon signal to determine an attenuation value of the power of the radio beacon signal between the transmitter and the mobile communication device,
applying the attenuation value to a power at which the radio communication signals are transmitted from the mobile communication device to determine the interference power, and
if the determined interference power is above a predetermined threshold, adapting the transmission of the radio communications signal.

36. A method according to claim 35, wherein the adapting of the transmission of the radio communication signals from the mobile communication device to reduce interference at the television receiver comprises changing a frequency band on which the radio communication signals are transmitted from the mobile communication device from a first frequency band to a second frequency band.

37. A method as claimed in claim 29, wherein the transmitting the radio beacon signal includes transmitting the radio beacon signal in accordance with a Bluetooth or WiFi radio protocol.

38. An audio/video apparatus comprising a television receiver, the television receiver comprising:
an antenna for receiving television signals;
a tuner for selecting the television signals transmitted on a carrier signal within a frequency band; and
a radio beacon transmitter for transmitting a radio beacon signal using a second antenna, the radio beacon signal being adapted to be received by a mobile communication device which is arranged to transmit radio communication signals on a frequency that can be received by the television receiver when the tuner is tuned to the television signals selected by the tuner; wherein
the radio beacon signal is arranged for detection by the mobile communication device, and the television receiver is configured to detect when the television receiver is reproducing sound and pictures from the television signals; and
the radio beacon transmitter is configured to transmit the radio beacon signal only when the television is reproducing sound and pictures from the television signals.

39. An audio/video apparatus as claimed in claim 38, wherein the television receiver is configured to detect when the television receiver is being used to reproduce sound and pictures from functions other than the television signals; and
the radio beacon transmitter is configured to switch off the radio beacon signal when the television is reproducing sound and pictures from other functions.

40. An audio/video apparatus as claimed in claim 39, wherein the other functions include reproducing sound and pictures from one of a storage media or from a games console.

41. An audio/video apparatus according to claim 38, wherein the frequency band of the carrier signal is 800 MHz frequency band, and the frequency on which the radio communication signals transmitted by the mobile communication device are transmitted is within the 800 MHz frequency band.

42. An audio/video apparatus according to claim 41, wherein the 800 MHz frequency band comprises frequencies between 790 and 862 MHz.

43. An audio/video apparatus according to claim 38, wherein the radio beacon transmitter is arranged to transmit the radio beacon signal at a fixed predetermined power.

44. An audio/video apparatus according to claim 38, wherein the audio/video apparatus is a television.

45. An audio/video apparatus according to claim 44, wherein the radio beacon transmitter is located within the television.

46. An audio/video apparatus according to claim 44, wherein the radio beacon transmitter is located externally of the television.

47. A mobile communication device comprising:
a transmitter for transmitting radio communication signals;
a receiver for receiving a radio beacon signal transmitted from an audio/video apparatus and a processor operable, on reception of the radio beacon signal, to adapt the transmission of the radio communication signals to reduce interference at the audio/video apparatus by:
determining, if the radio beacon signal is detected at the mobile communication device, a received power of the detected radio beacon signal, and
adapting the transmission of the radio communication signals from the mobile communication device to reduce interference at the television receiver in accordance with the received power of the detected radio beacon signal;
wherein the adapting of the transmission of the radio communication signals in accordance with the received power of the radio beacon signal comprises:
calculating an interference power of the radio communication signals at the television receiver based on the received power of the radio beacon signal, by using the received power of the radio beacon signal and a value corresponding to a predetermined power at which the radio beacon signal was transmitted to determine an attenuation value of the power of the radio beacon signal between the transmitter and the mobile communication device,
applying the attenuation value to a power at which the radio communication signals are transmitted from the mobile communication device to determine the interference power, and
if the determined interference power is above a predetermined threshold, adapting the transmission of the radio communications signal.

48. A mobile communication device according to claim 47, wherein the adapting of the transmission of the radio communication signals from the mobile communication device to reduce interference at the television receiver comprises changing a frequency band on which the radio communication signals are transmitted from the mobile communication device from a first frequency band to a second frequency band.

49. A mobile communication device according to claim 47, wherein the radio communication signals are transmitted within 800 MHz frequency band.

50. A mobile communication device according to claim 49, wherein the 800 Mhz frequency band comprises frequencies between 790 and 862 MHz.

51. A system for reducing interference to the reception of television signals received by a television receiver, the system comprising:
an audio/video apparatus comprising the television receiver, the television receiver comprising:
an antenna for receiving television signals;
a tuner for selecting the television signals transmitted on a carrier signal within a frequency band; and
a radio beacon transmitter for transmitting a radio beacon signal using a second antenna, the radio beacon signal being adapted to be received by a mobile communication device which is arranged to transmit radio communication signals on a frequency that can be received by the television receiver when the tuner is tuned to the television signals selected by the tuner; wherein
the radio beacon signal is arranged for detection by the mobile communication device, and the television receiver is configured to detect when the television is reproducing sound and pictures from the television signals; and
the radio beacon transmitter is configured to transmit the radio beacon signal only when the television is reproducing sound and pictures from the television signals; and
the mobile communication device comprising a transmitter for transmitting radio communication signals, a receiver for receiving a radio beacon signal transmitted from an audio/video apparatus and a processor operable, on reception of the radio beacon signal, to adapt the transmission of the radio communication signals to reduce interference at the audio/video apparatus by:
determining, if the radio beacon signal is detected at the mobile communication device, a received power of the detected radio beacon signal, and
adapting the transmission of the radio communication signals from the mobile communication device to reduce interference at the television receiver in accordance with the received power of the detected radio beacon signal;
wherein the adapting of the transmission of the radio communication signals in accordance with the received power of the radio beacon signal comprises:
calculating an interference power of the radio communication signals at the television receiver based on the received power of the radio beacon signal, by using the received power of the radio beacon signal and a value corresponding to a predetermined power at which the radio beacon signal was transmitted to determine an attenuation value of the power of the radio beacon signal between the transmitter and the mobile communication device,
applying the attenuation value to a power at which the radio communication signals are transmitted from the mobile communication device to determine the interference power, and
if the determined interference power is above a predetermined threshold, adapting the transmission of the radio communications signal.

52. A system according to claim 51, wherein the frequency band within which the television signals are received is 800 MHz frequency band, and the frequency on which the radio communication signals transmitted by the mobile communication device are transmitted is within the 800 MHz frequency band.

53. A system according to claim 51, wherein the 800 MHz frequency band comprises frequencies between 790 and 862 MHz.
